(19) United States
(12) Patent Application Publication
(10) Pub. No.: US 2008/0030991 A1
(43) Pub. Date: Feb. 7, 2008

(54) Base assembly for LEDs

(76) Inventor: Peter Yeh, Tainan Hsien (TW)

Correspondence Address: Thomas E. Sisson;Jackson Walker, LLP, Suite 2100, 112 E. Pecan, San Antonio, TX, 78205, US

(21) Appl. No.: 11/500,033

(22) Filed: Aug. 7, 2006

(51) Int. Cl. F21V 21/00

(52) U.S. Cl. 362/249

(57) ABSTRACT

A base assembly for LEDs has a top, a bottom and multiple LED recesses formed in the top and including at least one oblique LED recess and at least one perpendicular LED recess. Each oblique LED recess has an inclined bottom, an oblique sidewall and a pair of lead passages. The at least one perpendicular LED recess has a bottom parallel to the base. LEDs can be mounted respectively in the at least one oblique LED recess at an angle relative to the base and mounted upright in the perpendicular LED recess to emit lights in different directions to provide a wide-angle luminance effect. The cover is detachably mounted on the base and has at least one though hole and at least one mounting hole to allow the LEDs mounted in the LED recesses to protrude from and to be securely and exactly held in the base.

### BACKGROUND OF THE INVENTION

1. Field of the Invention

The present invention relates to a base assembly for light emitting diodes (LED) and more particularly to a base assembly on which LEDs can be securely and exactly mounted.

2. Description of Related Art

Because of low electricity consumption, LEDs are extensively used. Because a single LED does not have enough luminance for a lighting requirement, multiple LEDs are used to increase the luminance.

Each LED has two leads. To achieve adequate luminance, the LED leads are mounted in a central position and an outer position around the central position on a circuit board. To generate a wide-angle luminance effect, the leads of the LEDs around the central position are bent and tilted out so light is emitted from the circuit board at an angle. The LEDs in the central position emit light perpendicular to the circuit board.

However, the circuit board does not provide a feature to securely and exactly position the leads of the LED so the LEDs are not able to emit light at a specific angle.

Therefore, the invention provides a base assembly for LED to mitigate or obviate the aforementioned problems.

### SUMMARY OF THE INVENTION

The primary objective of the present invention is to provide a base assembly for LED, which has a base and provides a positioning effect to securely and exactly position LEDs on the base.

The base assembly for LEDs is mounted on a circuit board to hold LEDs. Each LED has a sidewall, a bottom and two leads protruding from the bottom. The base assembly has a base and a cover.

The base has a top, a bottom and multiple LED recesses. The LED recesses are formed in the top of the base to hold LEDs, and include at least one oblique LED recess and at least one perpendicular LED recess. Each oblique LED recess has a bottom, an oblique sidewall and a pair of lead passages. The bottom is inclined to support the bottom of the LED when the LED leads are bent. The oblique sidewall is adjacent and perpendicular to the bottom to support the sidewall of the LED perpendicular to the bottom so the LED emits light away from the bottom at a specific inclined angle relative to the base. The lead passages are formed through the bottom of the oblique LED recess and communicate with the bottom of the base to facilitate attaching the LED leads to exact positions on a circuit board.

The at least one perpendicular LED recess has a bottom and a pair of lead passages. The bottom is parallel to the base. The lead passages are formed through the bottom and communicate with the bottom of the base. Thus, the LED can be mounted upright in the perpendicular LED recess and emits light directly away from the base.

By emitting lights in different directions, the LEDs provide a wide-angle luminance effect.

The cover is mounted detachably on the top of the base and has at least one though hole and at least one mounting hole. The at least one through hole is formed through the cover and aligns respectively with the at least one perpendicular LED hole to allow the LEDs mounted in the LED recesses to protrude from and to be securely and exactly mounted in the base. The at least one mounting hole is formed through the cover and aligns respectively with the at least one oblique LED hole to allow the LEDs mounted in the LED recesses to protrude from and to be securely and exactly mounted in the base.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a base assembly for LEDs in accordance with the present invention;

FIG. 2 is an operational side view in partial section of the base assembly for LEDs in FIG. 1 before LEDs are mounted in a base of the base assembly;

FIG. 3 is an operational side view in partial section of the base assembly for LEDs in FIG. 1 with leads of the LEDs mounted in lead passages in the base;

FIG. 4 is an operational side view in partial section of the base assembly for LEDs in FIG. 1 with the leads of the LEDs bent;

FIG. 5 is an operational side view in partial section of the base assembly for LEDs in FIG. 1 with a cover mounted on the base; and

FIG. 6 is a perspective view of a second embodiment of the base assembly for LEDs in accordance with the present invention.

### DETAILED DESCRIPTION OF THE PREFERRED EMBODIMENT

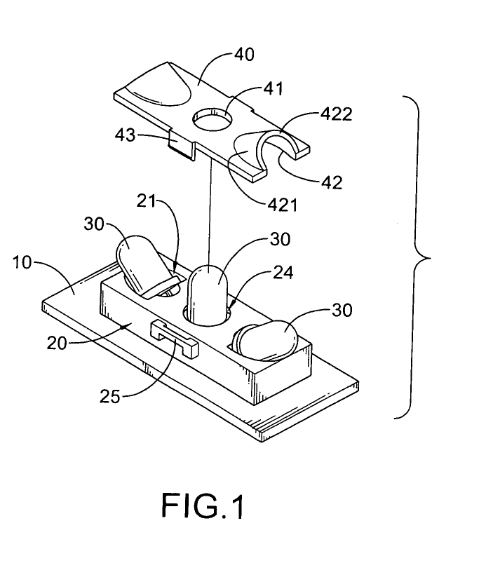

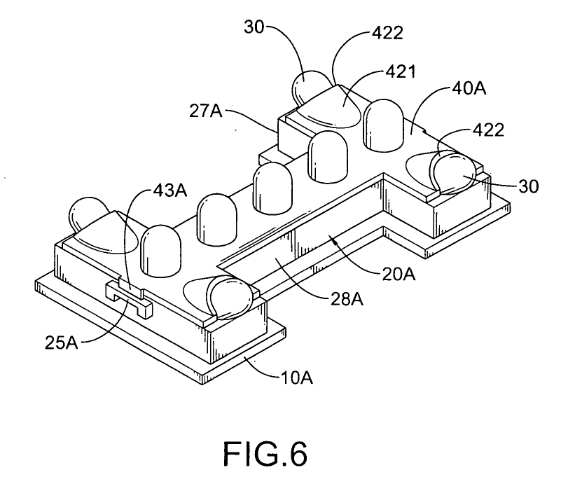

With reference to FIGS. 1 and 6, a base assembly for light emitting diodes (LEDs) in accordance with the present invention is mounted on a circuit board (10, 10A) to hold multiple LEDs (30) and comprises a base (20, 20A) and a cover (40, 40A).

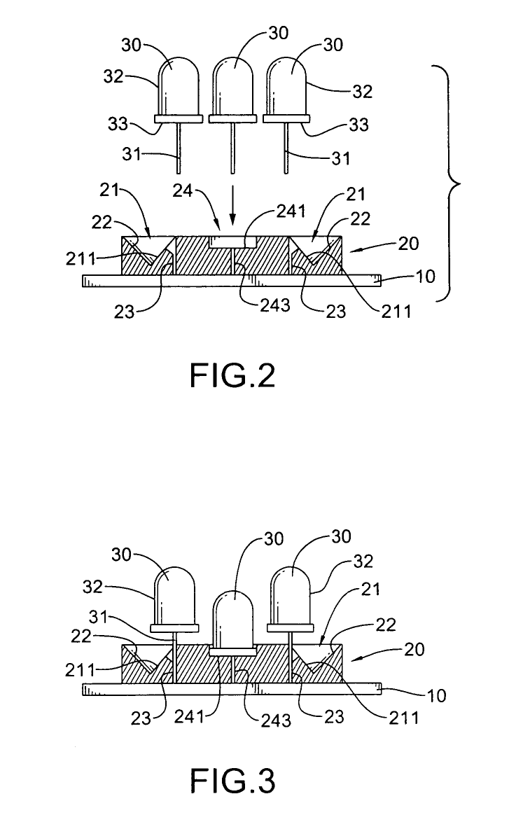

With further reference to FIG. 2, each LED (30) has a sidewall (32), a bottom (33) and two leads (31). With further reference to FIG. 3, the leads (31) protrude from the bottom (33) of the LED (30) and are connected to the circuit board (10, 10A).

The base (20, 20A) is mounted on the circuit board (10, 10A), has a top, a bottom, an outside, multiple LED recesses (21, 24) and multiple optional detents (25, 25A) and may be implemented in a multitude of individual configurations.

The LED recesses (21, 24) are formed in the top of the base (20, 20A) to hold the LEDs (30) and include at least one oblique LED recess (21) and at least one perpendicular LED recess (24).

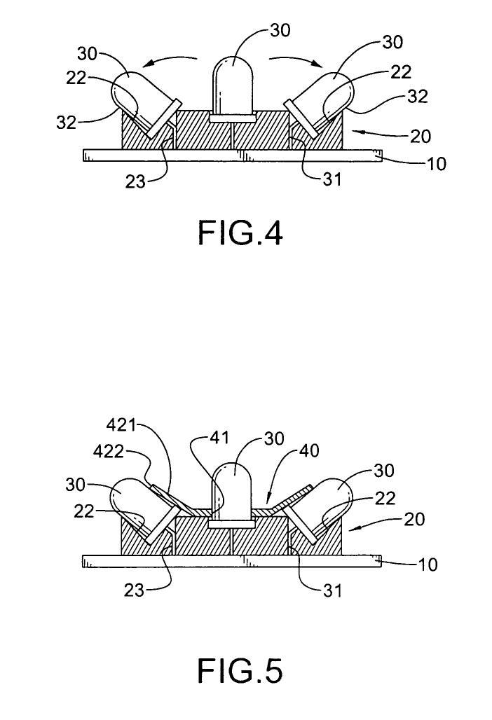

The at least one oblique LED recess (21) may be formed near the outside of the base (20, 20A). Each oblique LED recess (21) has a bottom (211), an oblique sidewall (22) and a pair of lead passages (23). With further reference to FIG. 4, the bottom (211) of the oblique LED recess (21) is inclined relatively to the bottom of the base (20, 20A)to support the bottom (33) of the LED (30) when the LED leads (31) are bent. The oblique sidewall (22) of the oblique LED recess (21) is formed adjacent and relative to the bottom (211) at a specific inclined angle and may be a curved surface or a flat surface. The specific inclined angle of the oblique sidewall (22) may tilt toward the outside of the base (20, 20A) so an LED (30) mounted in the oblique LED recess (21) is able to emit light outward to generate a wide-angle luminance effect. When the leads (31) of the LED (30) are bent and the sidewall (32) of the LED (30) is pressed against the oblique sidewall (22), the LED (30) tilts in the direction of the specific inclined angle. Thus, the LED (30) is capable of emitting lights toward a specific direction. The lead passages (23) are formed through the bottom (211) of the oblique LED recess (21), communicate with the bottom of the base (20, 20A), hold the leads (31) of the LED (30) and guide the leads (31) to the circuit board (10, 10A).

Each perpendicular LED recess (24) has a bottom (241) and a pair of lead passages (243). The bottom (241) of the perpendicular LED recess (24) is parallel to the bottom of the base (20, 20A), so the LED (30) is mounted upright in the LED recess (24) and emits lights directly away from the base (20, 20A) when the bottom (33) of the LED (30) is mounted flush against the bottom (241) of the perpendicular LED recess (24). The lead passages (243) are formed through the bottom (241) of the perpendicular LED recess (24), communicate with the bottom of the base (20, 20A), hold the leads (31) of the LED (30) and guide the leads (31) to the circuit board (10, 10A).

The detents (25, 25A) are formed on and protrude from the outside of the base (20, 20A).

A couple of examples of the multitude of individual configurations include a rectangular first embodiment of the base (20) and an H- or I-shaped second embodiment of the base (20A).

The cover (40, 40A) is mounted detachably on the top of the base (20, 20A) and has an outer edge, at least one though hole (41), at least one mounting hole (42), at least one inclined sidewall (421) and multiple optional mounting tabs (43, 43A).

The at least one through hole (41) is formed through the cover (40, 40A) and aligns respectively with the at least one perpendicular LED hole (24) to allow the LED (30) to be mounted in a corresponding perpendicular LED hole (24) to protrude from the through hole (41) and to securely and exactly hold the LED (30).

The at least one mounting hole (42) is formed though the cover (40, 40A) and aligns respectively with the at least one oblique LED hole (21) to allow the LED (30) mounted in a corresponding oblique LED hole (21) to protrude from the mounting hole (42), and each mounting hole (42) has an edge.

The at least one inclined sidewall (421) is formed on and protrudes out from the edge of the at least one mounting hole (42) and presses against and holds the LED (30) in the corresponding oblique LED hole (21). Each inclined sidewall (421) has an end surface and an opening (422). The opening (422) is formed through the end surface of the inclined sidewall (421) to allow the LED (30) to protrude from the cover (40, 40A).

The mounting tabs (43, 43A) are formed on and protrude down from the outer edge of the cover (40, 40A) and correspond respectively to and selectively engage the detents (25, 25A) on the base (20, 20A) to hold the cover (40, 40A) on the base (20, 20A).

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A base assembly for LEDs being mounted on a circuit board, the base assembly comprising
a base being adapted to be mounted on the circuit board and having a top;
a bottom;
an outside; and
multiple LED recesses being formed in the top of the base and including
at least one oblique LED recess, and each one of the at least one oblique LED recess having
a bottom being inclined relatively to the bottom of the base;
an oblique sidewall being formed adjacent and relative to the bottom of the oblique LED recess at a specific inclined angle; and
a pair of lead passages formed through the bottom of the oblique LED recess, communicating with the bottom of the base; and
at least one perpendicular LED recess, and each one of the at least one perpendicular LED recess having
a bottom being parallel to the bottom of the base; and
a pair of lead passages being formed through the bottom of the perpendicular LED recess, communicating with the bottom of the base; and
a cover being mounted detachably on the top of the base and having
an outer edge;
at least one though hole being formed through the cover and aligning respectively with the at least one perpendicular LED hole;
at least one mounting hole being formed though the cover and aligning respectively with the at least one oblique LED hole and each one of the at least one mounting hole having an edge; and
at least one inclined sidewall being formed on and protruding out from each edge of the at least one mounting hole and each inclined sidewall having
an end surface; and
an opening being formed through the end surface of the inclined sidewall.

2. The base assembly as claimed in claim 1, wherein
the at least one oblique LED recess is formed near the outside of the base; and
the specific inclined angle of the oblique sidewall of each one of the at least one oblique LED recess tilts toward the outside of the base.

3. The base assembly as claimed in claim 1, wherein
the base further has multiple detents formed on and protruding from the outside of the base; and
the cover further has multiple mounting tabs formed on and protruding down from the outer edge of the cover and corresponding respectively to and selectively engaging the detents on the base.

4. The base assembly as claimed in claim 1, wherein the base is rectangular.

5. The base assembly as claimed in claim 1, wherein the base is I-shaped.

6. The base assembly as claimed in claim 1, wherein the base is H-shaped.
